(19) United States
(12) Patent Application Publication
(10) Pub. No.: US 2006/0136216 A1
(43) Pub. Date: Jun. 22, 2006

(54) Text-to-speech system and method thereof

(75) Inventors: Jia-Lin Shen, Lujhou City (TW); Wen-Wei Liao, Longtan Township (TW); Ching-Ho Tsai, Huatan Township (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, INC., Taoyuan Country (TW)

(21) Appl. No.: 11/298,028

(22) Filed: Dec. 9, 2005

(30) Foreign Application Priority Data
Dec. 10, 2004 (TW) 093138499

(51) Int. Cl. G10L 13/00

(52) U.S. Cl. 704/266

(57) ABSTRACT

The present invention is related to a text-to-speech system, including a text processor dividing a first text data and a second text data from a text string having at least a first language and a second language; a database including a plurality of acoustic units commonly used by the first and second languages; a first speech synthesis unit and a second speech synthesis unit generating a first speech data corresponding to the first text data and a second speech data corresponding to the second text data respectively by using the plurality of acoustic units; and a prosody processor optimizing prosodies of the first and second speech data.

### FIELD OF THE INVENTION

The present invention relates to a text-to-speech system and the method thereof, and more particularly to a multi-language text-to-speech system and the method thereof.

### BACKGROUND OF THE INVENTION

For a text-to-speech system, the text has only the linguistic features whether the input data is a paragraph or an article. It means the text does not contain any acoustic features, for example, tones, durations or speeds. Therefore, the system has to generate possible acoustic features of these texts through an automatic prediction. Recently, the stringing method is very popular, which picks up a sound unit corresponding to the word from a prerecorded database.

The major function of a text-to-speech system is to convert a text input to a fluent speech output. Please refer to FIG. 1, which is a flow chart illustrating the conventional process of converting an input text into a speech according to a single language. The input text is divided into several semantic segments through linguistic processing, and each semantic segment contains a relevant acoustic unit. The consideration for linguistic processing varies with different languages. For example, after the linguistic processing, such as syllables and accents of each word, an English sentence “Have you had breakfast” reads like “Have (h ae v) you (yu) had (h ae d) breakfast (b r ey k f a st)”. However, after the linguistic processing, a Chinese sentence [symbol] [symbol] will become [symbol] (ni3) [symbol] (chil guo4) [symbol] (zao3 can1) [symbol] (le3) [symbol] (ma5)”, where some words have been determined as a meaningful term. After the linguistic processing, each semantic segment is assembled as a relevant speech data. Finally, the prosody processing is taken to adjust pitch contours, volumes and durations of each acoustic unit of the sentence.

A multi-language text-to-speech system and method are disclosed in the U.S. Pat. No. 6,141,642. The method includes different linguistic processing systems to proceed tasks of text-to-speech in different languages respectively, and then the combination of speech data from different processing systems is output. In the U.S. Pat. No. 6,243,681B1, a multi-language speech synthesizer for a computer telephony integration system is disclosed. The disclosed multi-language speech synthesizer includes several speech synthesizers for text-to-speech with different languages. Then, the speech data from different linguistic processing systems are combined and output

The above-mentioned US patents are both based on the combination of different acoustic databases of different languages. When the speech data is output, users will hear different sounds of each language, which means the voices and the prosodies are different and inconsistent. Further, even all words of each language could be recorded by the same speaker, it spends lots of efforts and is not easily achievable.

In order to overcome the foresaid drawbacks in the prior arts, the present invention provides a text-to-speech system and the method thereof, especially a multi-language text-to-speech system and the method thereof.

### SUMMARY OF THE INVENTION

It is an aspect of the present invention to provide a text-to-speech system, including a text processor dividing a first text data and a second text data from a text string having at least a first language and a second language; a database including a plurality of acoustic units commonly used by the first and second language; a first speech synthesis unit and a second speech synthesis unit generating a first speech data corresponding to the first text data and a second speech data corresponding to the second text data respectively by using the plurality of acoustic units; and a prosody processor optimizing prosodies of the first and second speech data.

Preferably, the first and second text data include acoustic data respectively.

Preferably, the plurality of acoustic units are recorded from the same speaker.

Preferably, the prosody processor includes a reference prosody.

More preferably, the prosody processor determines a first prosody parameter and a second prosody parameter for the first speech data and the second speech data respectively according to the reference prosody.

More preferably, the first and second prosody parameters define tones, volumes, speeds and durations for the first and second speech data.

More preferably, the prosody processor connects the first speech data with the second speech data in a hierarchical manner according to the first and second prosody parameters to obtain a successive prosody thereof.

More preferably, the prosody processor further adjusts connected the first speech data and the second speech data.

It is another aspect of the present invention to provide a method for a text-to-speech conversion, including steps of: (a) providing a text string comprising at least a first language and a second language; (b) discriminating a first text data and a second text data from the text string; (c) providing a database having a plurality of acoustic units commonly used by the first and second languages; (d) generating a first speech data corresponding to the first text data and a second speech data corresponding to the second text data respectively by using the plurality of acoustic units; and (e) optimizing prosodies of the first and second speech data.

Preferably, the first and second text data include acoustic data respectively.

Preferably, the plurality of acoustic units are recorded from the same speaker.

Preferably, the step (e) further includes a step (e1) of providing a reference prosody.

More preferably, the step (e) further includes a step (e2) of determining a first prosody parameter and a second prosody parameter for the first and second speech data respectively according to the reference prosody.

More preferably, the first and second prosody parameters define tones, volumes, speeds and durations of the first and second speech data.

Preferably, the step (e) further includes a step (e3) of connecting the first and second speech data in a hierarchical manner according to the first and second prosody parameters to obtain a successive prosody.

More preferably, the step (e) further includes a step (e4) of adjusting connected the first and second speech data.

It is a further aspect of the present invention to provide a text-to-speech system, including: a text processor discriminating a first text data and a second text data from a text data comprising at least a first language and a second language; a translation module translating the second text data to a translated data in the first language; a speech synthesis unit receiving the first text data and the translated data and generating a speech data therefrom; and a prosody processor optimizing a prosody of the speech data.

Preferably, the second text data is at least one selected from a group consisting of a word, a phrase and a sentence.

Preferably, the speech synthesis unit further includes an analyzing module for rearranging the first text data and the translated data to obtain the speech data with a correct grammar and meaning according to the first language.

Preferably, the prosody processor includes a reference prosody.

More preferably, the prosody processor determines a prosody parameter for the speech data according to said reference prosody.

More preferably, the prosody parameters defines tones, volumes, speeds and durations of the speech data.

More preferably, the prosody processor adjusts the speech data according to the prosody parameters to obtain a successive prosody thereof.

It is further another aspect of the present invention to provide a method for a text-to-speech conversion, including steps of: (a) providing a text data comprising at least a first language and a second language; (b) dividing a first text data and a second text data from the text data; (c) translating the second text data to a translated data in the first language; (d) generating a speech data corresponding to the first text data and the translated data; and (e) optimizing a prosody of the speech data.

Preferably, the second text data is at least one selected from a group consisting of a word, a phrase and a sentence.

Preferably, the step (d) further includes a step (d1) of rearranging the first text data and the translated data according to grammar and meanings of the first language to obtain the speech data with a correct grammar and meaning.

Preferably, the step (e) further includes a step (e1) of providing a reference prosody.

More preferably, the step (e) further includes a step (e2) of determining a prosody parameter of the speech data according to the reference prosody.

More preferably, the prosody parameters defines a tone, volume, speed, and duration of the speech data.

More preferably, the step (e) further includes a step (e3) of adjusting the speech data according to the prosody parameters to obtain a successive prosody thereof.

The above aspects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a flow chart illustrating the conventional process of converting an input text into a speech according to a single language;

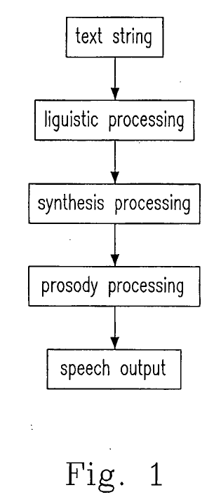

FIG. 2A is a schematic view illustrating a text-to-speech system according to a preferred embodiment of the present invention;

FIG. 2B is a schematic view illustrating a text-to-speech method according to a preferred embodiment of the present invention;

FIG. 3 is a schematic view illustrating a text-to-speech system according to another preferred embodiment of the present invention;

FIG. 4 is a schematic view illustrating a text-to-speech system according to another preferred embodiment of the present invention;

FIG. 5A is a schematic view illustrating a text-to-speech system according to another preferred embodiment of the present invention;

FIG. 5B is a schematic view illustrating a text-to-speech method according to another preferred embodiment of the present invention; and

FIG. 6 is a schematic view illustrating a text-to-speech system according to another preferred embodiment of the present invention.

### DETAILED DESCRIPTION OF THE PREFERRED EMBODIMENT

The present invention will be described more specifically with reference to the following embodiments. It is to be noted that the following descriptions of preferred embodiments of this invention are presented herein for the purposes of illustration and description only; it is not intended to be exhaustive or to be limited to the precise form disclosed.

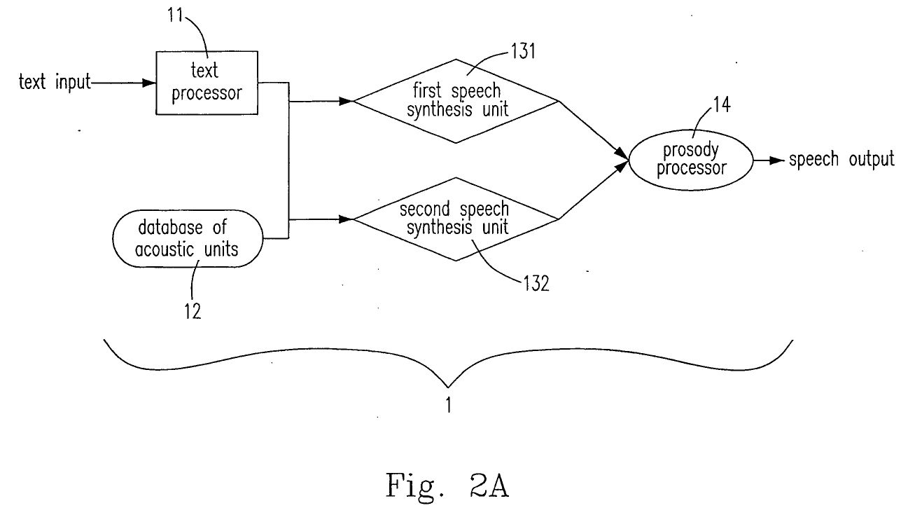

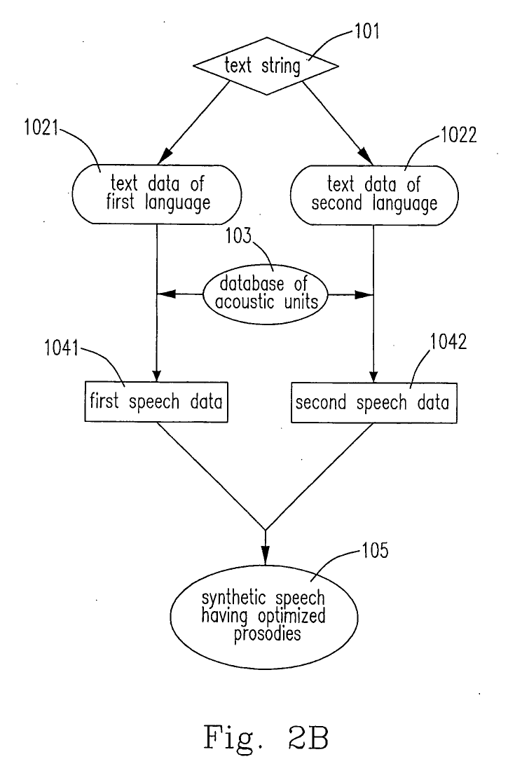

Please refer to FIG. 2A, which is a schematic view illustrating a text-to-speech system according to the first preferred embodiment of the present invention. The text-to-speech system 1 according to the present invention includes a text processor 11, a database of acoustic units 12, a first speech synthesis unit 131, a second speech synthesis unit 132 and a prosody processor 14.

The components of the text-to-speech system and the functions thereof are described below. The text processor 11 receives a text string, which includes a text data of at least a first language and a second language. The text processor 11 divides a first text data and a second text data from the text string according to different languages, and the first text data and the second text data contain acoustic data and semantic segments. The database of acoustic units 12 includes a plurality of acoustic units, which are commonly used by the first language and the second language. Preferably, the database of acoustic units 12 is recorded from the same speaker.

The first speech synthesis unit 131 and the second speech synthesis unit 132 automatically acquire the acoustic units defined in the first language and the second languages through the algorithm. When the acoustic units defined in the first language and the second language are the commonly used acoustic units in the database, the first and second speech synthesis units then synthesize the speech with the commonly used acoustic units, and generate a first speech data corresponding to the first text data and a second speech data corresponding to the second text data respectively.

The prosody processor 14 receives the first and second speech data and optimizes the prosodies thereof. The prosody processor 14 includes a reference prosody, and the prosody processor 14 determines a first prosody parameter and a second prosody parameter for the first and second speech data respectively according to the reference prosody. The first and second prosody parameters represent tones, volumes, speeds and durations for the first and second speech data respectively. Then, the prosody processor 14 connects the first speech data with the second speech data in a hierarchical manner according to the first and second prosody parameters to obtain a successive prosody thereof. Thus, a fluent synthetic speech is output.

FIG. 2B is a schematic view illustrating a text-to-speech method according to a preferred embodiment of the present invention. The text-to-speech method according to the present invention includes the steps of providing a text string 101 including at least a first language and a second language, discriminating a first text data 1021 and a second text data 1022 from the text string where the first and second text data 1021, 1022 contain acoustic data and semantic segments, providing a database of acoustic units 103 having a plurality of acoustic units commonly used by the first language and the second language, generating a first speech data 1041 corresponding to the first text data 1021 and a second speech data 1042 corresponding to the second text data 1022 respectively by using the plurality of acoustic units, and finally, optimizing prosodies of the first speech data 1041 and the second speech data 1042 to form a synthetic speech having optimized prosodies for outputting.

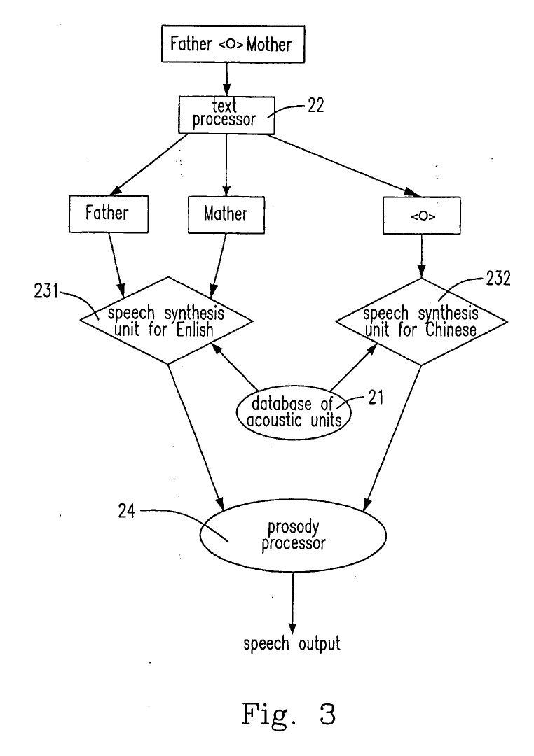

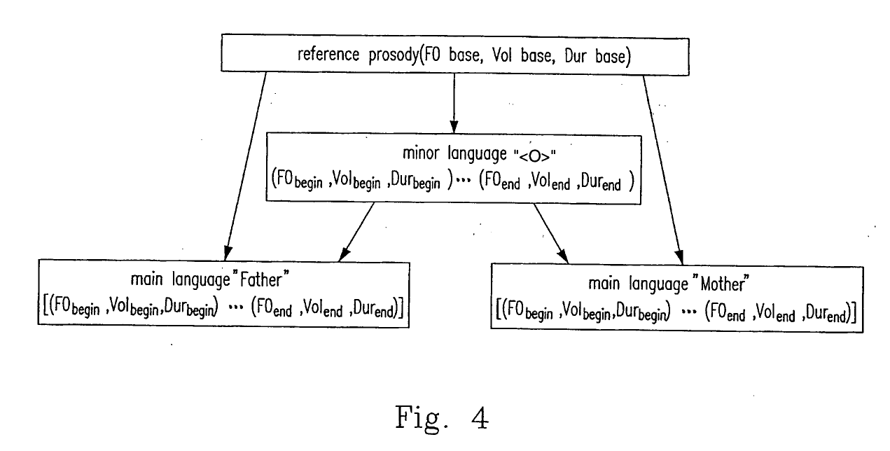

FIGS. 3 and 4 are schematic views illustrating a text-to-speech system according to the second embodiment of the present invention. Please refer to FIG. 3, the database of acoustic units 21 has acoustic units commonly used for multiple languages. When the text processor 22 according to the present invention receives the text string “father [symbol] mother”, the text processor 22 discriminates the text string to three text data, i.e. “father”, [symbol] and “mother” according to Chinese and English respectively. The text data contain acoustic data and are further divided into “fa”, “th”, “er”, [symbol] , “mo”, “th”, and “er”. Since the acoustic units of “fa” and “mo” are commonly used by Chinese and English in the database, the English speech synthesis unit 231 will acquire the defined acoustic units through an algorithm automatically after receiving the text data of “father” and “mother”. The acoustic units of “fa” and “mo” are acquired directly from the database 21, and the acoustic units of “th” and “er” are picked up from the database of English speech synthesis unit 231. Therefore, the English speech of the word “father” and “mother” are generated.

The Chinese speech synthesis unit 232 receives the text data of [symbol] and also tries to acquire the acoustic unit through the algorithm. However, the acoustic unit of [symbol] is not built in the database; it is generated from the database of the Chinese speech synthesis unit 232. Therefore, the Chinese speech of [symbol] is synthesized.

Then, the synthetic Chinese and English are input into the prosody processor 24 for overall prosody processing. Please refer to FIG. 4, the input text string “father [symbol] mother” is converted by the text-to-speech system according to the present invention. The output speech is proceeded in English and Chinese alternatively. In order to perform the synthetic speech of different languages fluently, it is required to adjust tones (F0 base), volumes (Vol base), speeds (Speed base) and durations. The prosody processor of the present invention has a reference prosody as the basis for adjustment. Furthermore, the prosody parameters defines tones, volumes, speeds and durations of each speech data. Therefore, the prosody processor of the present invention connects different languages in a hierarchical manner according to the reference prosodies and prosody parameters to obtain a successive prosody. For example, in this preferred embodiment, the text string “father [symbol] mother” includes a main language, i.e. English and a minor language, i.e. Chinese. The prosody parameters “(F0_{b}, Vol_{b}) and (F0ₑ, Volₑ)” of the minor language [symbol] is determined according to the reference prosody. After that, the prosody parameters of the main language is determined. Then, the prosody processor further adjusts the prosody parameters of the main language “father” and “mother” to “(F0₁, Vol₁) . . . (F0ₙ, Volₙ)” and “(F0₁, Vol₁) . . . (F0ₘ, Volₘ)” respectively according to the prosody parameters of the minor language in order to obtain a successive prosody thereof.

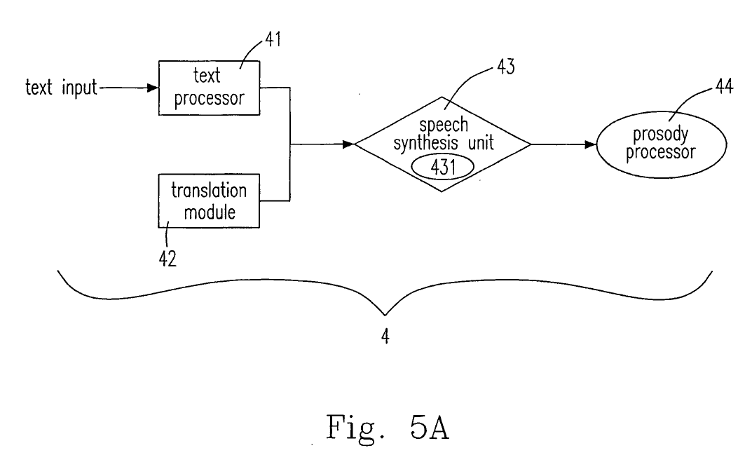

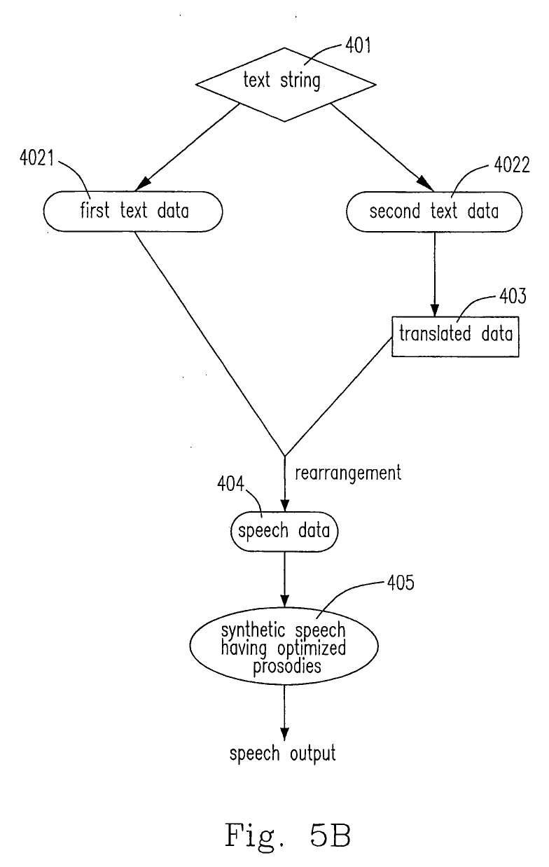

Please refer to FIG. 5A, which is a schematic view illustrating a text-to-speech system according to the third embodiment of the present invention. The text-to-speech system 4 according to the present invention includes a text processor 41, a translation module 42, a speech synthesis unit 43 and a prosody processor 44. The components of the text-to-speech system 4 and the functions thereof are described as below. The text processor 41 receives a text string, which contains at least a first language and a second language. The text processor 41 divides a first text data and a second text data from the text data according to the first and second languages, and the second text data includes at least one selected from a group consisting of a word, a phrase and a sentence. The translation module 42 then translates the second text data to a translated data in a form of the first language. The speech synthesis unit 43 receives the first text data as well as the translated data and then generates a speech data. The speech synthesis unit 43 further includes an analyzing module 431, which rearranges the first text data and the translated data to obtain the speech data with a correct grammar and meaning. The prosody processor 44 is used for optimizing the prosody of the speech data. The prosody processor 44 further contains a reference prosody, and according to the reference prosody, the prosody processor 44 determines the prosody parameters of the speech data. The prosody parameters defines tones, volumes, speeds and durations of the speech data, and then the prosody processor 44 adjusts the speech data according to the prosody parameters to obtain a successive prosody thereof.

FIG. 5B is a schematic view illustrating a text-to-speech method according to another preferred embodiment of the present invention. The text-to-speech method according to the present invention includes: providing a text string 401 containing at least a first language and a second language; dividing a first text data 4021 and a second text data 4022, which includes at least one selected from a group consisting of a word, a phrase and a sentence from the text string; translating the second text data to a translated data 403 in a form of the first language; rearranging the first text data 4021 and the translated data 403 according to the grammar and meanings of the first language to obtain a speech data 404 with a correct grammar and meaning; optimizing a prosody of the speech data 403 to obtain the synthetic speech 405 having optimized prosodies; and outputting the speech. According to the present invention, the method for optimizing the prosody of the speech data includes the steps of providing a reference prosody, determining the prosody parameters of the speech data which defines tones, volumes, speeds and durations of the speech, and adjusting the speech data according to the prosody parameters to obtain a successive prosody thereof.

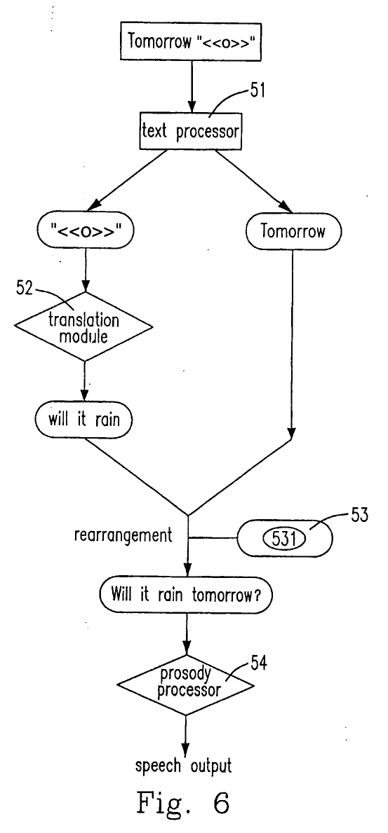

FIG. 6 is the fourth embodiment of the present invention, which illustrates the text-to-speech system according to the present invention. A text string “tomorrow [symbol] is input into the text processor 51, and the text string is divided to text data “tomorrow” and [symbol] according to English and Chinese respectively. The text data [symbol] is translated to English text data “will it rain?” by a translation module 52. Then the speech synthesis unit 53 receives text data “tomorrow” and “will it rain?” and converts the text data into a speech data. The speech synthesis unit further includes an analyzing module, which rearranges the received text data “tomorrow” and “will it rain?” to obtain the speech data “Will it rain tomorrow?” with a correct grammar and meaning according to the English grammar and meanings. The prosody processor 54 is used for optimizing the prosodies of the speech data. The prosody processor 54 further contains a reference prosody and determines a prosody parameter of the speech data according to the reference prosody. The prosody parameters defines tones, volumes, speeds and durations of the speech. Therefore, the prosody processor 54 can adjust the speech data according to the prosody parameters to obtain a successive prosody thereof.

The above-mentioned embodiments are illustrated in the combination of Chinese and English speech. However, the text-to-speech system and method according to the present invention can be applied to other combinations of different languages.

According to the present invention, the text-to-speech system and method can convert a text string, which is a combination of several languages, into a native and fluent multi-language synthetic speech through a database of acoustic units and prosody processing. Besides, the text-to-speech system and method according to the present invention further includes a translation module for translating a text string, which is a combination of several languages, to a native and fluent multi-language synthetic speech through the translation module and prosody processing. The text-to-speech system and method according to the present invention overcome the drawbacks of a faltering speech when a multi-language text-to-speech conversion is processed in the prior arts.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A text-to-speech system, comprising:
a text processor dividing a first text data and a second text data from a text string having at least a first language and a second language;
a database comprising a plurality of acoustic units commonly used by said first and second language;
a first speech synthesis unit and a second speech synthesis unit generating a first speech data corresponding to said first text data and a second speech data corresponding to said second text data respectively by using said plurality of acoustic units; and
a prosody processor optimizing prosodies of said first and second speech data.

2. The text-to-speech system according to claim 1, wherein said first and second text data comprise acoustic data respectively.

3. The text-to-speech system according to claim 1, wherein said plurality of acoustic units are recorded from the same speaker.

4. The text-to-speech system according to claim 1, wherein said prosody processor comprises a reference prosody.

5. The text-to-speech system according to claim 4, wherein said prosody processor determines a first prosody parameter and a second prosody parameter for said first and second speech data respectively according to said reference prosody.

6. The text-to-speech system according to claim 5, wherein said first and second prosody parameters define tones, volumes, speeds and durations of said first and second speech data.

7. The text-to-speech system according to claim 5, wherein said prosody processor connects said first speech data with said second speech data in a hierarchical manner according to said first and second prosody parameters to obtain a successive prosody thereof.

8. The text-to-speech system according to claim 7, wherein said prosody processor further adjusts connected said first and second speech data.

9. A method for a text-to-speech conversion, comprising steps of:
(a) providing a text string comprising at least a first language and a second language;
(b) discriminating a first text data and a second text data from said text string;
(c) providing a database having a plurality of acoustic units commonly used by said first language and said second language;
(d) generating a first speech data corresponding to said first text data and a second speech data corresponding to said second text data respectively by using said plurality of acoustic units; and
(e) optimizing prosodies of said first and second speech data.

10. The method according to claim 9, wherein said first and second text data comprise acoustic data respectively.

11. The method according to claim 9, wherein said plurality of acoustic units are recorded from the same speaker.

12. The method according to claim 9, wherein the step (e) further comprises a step (e1) of providing a reference prosody.

13. The method according to claim 12, wherein the step (e) further comprises a step (e2) of determining a first prosody parameter and a second prosody parameter for said first and second speech data respectively according to said reference prosody.

14. The method according to claim 13, wherein said first and second prosody parameters define tones, volumes, speeds and durations of said first and second speech data.

15. The method according to claim 13, wherein the step (e) further comprises a step (e3) of connecting said first and second speech data in a hierarchical manner according to said first and second prosody parameters to obtain a successive prosody.

16. The method according to claim 15, wherein the step (e) further comprises a step (e4) of adjusting connected said first and second speech data.

17. A text-to-speech system, comprising:
a text processor discriminating a first text data and a second text data from a text data comprising at least a first language and a second language;
a translation module translating said second text data to a translated data in said first language;
a speech synthesis unit receiving said first text data and said translated data and generating a speech data therefrom; and
a prosody processor optimizing a prosody of said speech data.

18. The text-to-speech system according to claim 17, wherein said second text data is at least one selected from a group consisting of a word, a phrase and a sentence.

19. The text-to-speech system according to claim 17, wherein said speech synthesis unit further comprises an analyzing module for rearranging said first text data and said translated data to obtain said speech data with a correct grammar and meaning according to said first language.

20. The text-to-speech system according to claim 17, wherein said prosody processor comprises a reference prosody.

21. The text-to-speech system according to claim 20, wherein said prosody processor determines a prosody parameter for said speech data according to said reference prosody.

22. The text-to-speech system according to claim 21, wherein said prosody parameters defines tones, volumes, speeds and durations of said speech data.

23. The text-to-speech system according to claim 21, wherein said prosody processor adjusts said speech data according to said prosody parameters to obtain a successive prosody thereof.

24. A method for a text-to-speech conversion, comprising steps of:
(a) providing a text data comprising at least a first language and a second language;
(b) dividing a first text data and a second text data from said text data;
(c) translating said second text data to a translated data in said first language;
(d) generating a speech data corresponding to said first text data and said translated data; and
(e) optimizing a prosody of said speech data.

25. The method according to claim 24, wherein said second text data is at least one selected from a group consisting of a word, a phrase and a sentence.

26. The method according to claim 24, wherein said step (d) further comprises a step (d1) of rearranging said first text data and said translated data according to grammar and meanings of said first language to obtain said speech data with a correct grammar and meaning.

27. The method according to claim 24, wherein said step (e) further comprises a step (e1) of providing a reference prosody.

28. The method according to claim 27, wherein said step (e) further comprises a step (e2) of determining a prosody parameter of said speech data according to said reference prosody.

29. The method according to claim 28, wherein said prosody parameters defines tones, volumes, speeds, and durations of said speech data.

30. The method according to claim 27, wherein said step (e) further comprises a step (e3) of adjusting said speech data according to said prosody parameters to obtain a successive prosody thereof.
